(19) United States
(12) Patent Application Publication
(10) Pub. No.: US 2025/0086324 A1
(43) Pub. Date: Mar. 13, 2025

(54) Method and Arrangement for Authenticating Digital Snapshots

(71) Applicant: Siemens Schweiz AG, Zürich (CH)

(72) Inventor: Christian Frey, Unterägeri (CH)

(73) Assignee: Siemens Schweiz AG, Zürich (CH)

(21) Appl. No.: 18/728,206

(22) PCT Filed: Dec. 21, 2022
(86) PCT No.: PCT/EP2022/087382

§ 371 Date: Jul. 11, 2024

(30) Foreign Application Priority Data
Jan. 11, 2022 (DE) 10 2022 200 200.8

(51) Int. Cl. G06F 21/64

(52) U.S. Cl. CPC G06F 21/64

(57) ABSTRACT

A method and arrangement for authenticating digital snapshots, wherein a digital snapshot is created by a capture device by a user using a first capture apparatus, wherein at the same time as the creation of the digital snapshot, a digital, in particular a digital-visual, identifier of the user is determined by a second capture apparatus, wherein the digital identifier of the user is overlaid into the digital snapshot and/or is added digitally, and wherein the digital snapshot containing the digital identifier of the user is stored in a machine-readable format.

### CROSS-REFERENCE TO RELATED APPLICATIONS

This application is a U.S. National Stage Application of International Application No. PCT/EP2022/087382 filed Dec. 21, 2022, which designates the United States of America, and claims priority to DE Application No. 10 2022 200 200.8 filed Jan. 11, 2022, the contents of which are hereby incorporated by reference in their entirety.

### TECHNICAL FIELD

The present disclosure relates to digital information. Various embodiments of the teachings herein include methods and/or systems for authenticating digital snapshots.

### BACKGROUND

The built-in cameras of smartphones are often used to document service work or repairs. In some cases, these digital photographs are already automatically imported online into an appropriate system (for example into a cloud). This can serve as proof that someone has for example completed a service job or has identified an error. However, it is not clear who this was. In other words, it is not possible to determine who took the photograph. Yet this information may be particularly crucial for inspections of safety-related systems or the professional examination thereof.

Known methods for increasing the evidential value of digital photographs include the integration of contextual data. Thus it is possible to integrate particular data, such as date, time and place, into the file. Time and place can for example be recorded by a secure system time and a GPS module. To increase the evidential value of digital photographs it is further known to use digital security measures, such as digital watermarks or electronic signatures, for example. Although these methods prove that the appropriate smartphone has been used, it is still not clear who took the photograph and thus who is responsible for the service provided.

### SUMMARY

The teachings of the present disclosure provide methods and/or systems for simple and secure proof of identity of the creator of a digital snapshot. For example, some embodiments include a method for authenticating digital snapshots (for example digital photographs, digital point videos, cloud provided by an appropriate scanning device), (VS1) wherein a digital snapshot is created by a capture device (appropriate digital camera, smartphone, scanner) by a user (for example facility manager, maintenance engineer) using a first capture apparatus (for example primary camera, front camera of a smartphone), (VS2) wherein at the same time as the creation of the digital snapshot a digital, in particular a digital-visual, identifier of the user (i.e. the person who created the digital snapshot) is created by a second capture apparatus (for example rear secondary camera of a smartphone), (VS3) wherein the digital identifier of the user is overlaid into the digital snapshot and/or is added digitally, and (VS4) wherein the digital snapshot containing the digital identifier of the user is stored in a machine-readable format, (VS5) wherein a digital watermark and/or a further digital identifier (for example PKI) of the user and/or a digital signature of the user and/or the name of the user is overlaid on the digital snapshot and/or is added digitally, (VS6) wherein the identity of the user is examined by a certified infrastructure and is stored in the digital snapshot.

In some embodiments, the digital identifier (DIK1-DIK4) of the user (B1-B3) takes the form of facial recognition (FaceID) and/or a digital photograph.

In some embodiments, current-location GPS data and/or current time information (Z) is overlaid on the digital snapshot (DBA1-DBA4, DBA1′, DBA2′) and/or is added digitally.

In some embodiments, the digital snapshot (DBA1-DBA4, DBA1′, DBA2′) is used as construction progress documentation for the creation of a structure, and the digital snapshot (DBA1-DBA4, DBA1′, DBA2′) is stored in a digital construction diary.

In some embodiments, the digital snapshot (DBA1-DBA4, DBA1′, DBA2′) containing the digital identifier (DIK1-DIK4) of the user (B1-B3) is assigned in a building information model (BIM).

In some embodiments, the method is implemented by an appropriately configured mobile communication terminal (MG1-MG3, MG2).

In some embodiments, the digital snapshot (DBA1-DBA4, DBA1′, DBA2′) includes the documentation of parameters and/or configurations and/or measured values of a technical system.

As another example, some embodiments include an arrangement for performing a method as described herein.

As another example, some embodiments include an arrangement for authenticating digital snapshots (DBA1-DBA4, DBA1′, DBA2′), wherein a digital snapshot (DBA1-DBA4, DBA1′, DBA2) is created by a capture device (MG1-MG3, MG2′) by a user (B1-B3) using a first capture apparatus (EAE), wherein a digital identifier (DIK1-DIK4) of the user (B1-B3) can be determined by a second capture apparatus (ZEA) at the same time as the digital snapshot (DBA1-DBA4, DBA1′, DBA2′), wherein the digital identifier (DIK1-DIK4) of the user (B1-B3) is overlaid, in particular visually, into the digital snapshot (DBA1-DBA4, DBA1′, DBA2′) and/or can be added digitally, and wherein the digital snapshot (DBA1-DBA4, DBA1′, DBA2′) containing the digital identifier (DIK1-DIK4) of the user (B1-B3) can be stored in a machine-readable format on a suitable storage medium, wherein a digital watermark and/or a further digital identifier (for example PKI) of the user (B1-B3) and/or a digital signature of the user (B1-B3) and/or the name (BN1, BN2) of the user (B1-B3) are overlaid on the digital snapshot (DBA1-DBA4, DBA1′, DBA2′) and/or can be added digitally, wherein the identity of the user, following verification by a certified infrastructure, can be stored in the digital snapshot (DBA1-DBA4, DBA1′, DBA2′).

In some embodiments, the digital identifier (DIK1-DIK4) of the user (B1-B3) takes the form of facial recognition (FaceID) and/or a digital photograph.

In some embodiments, current-location GPS data is overlaid on the digital snapshot (DBA1-DBA4, DBA1′, DBA2′) and/or is added digitally.

In some embodiments, the digital snapshot (DBA1-DBA4, DBA1′, DBA2′) is used as construction progress documentation for the creation of a structure, and the digital snapshot (DBA1-DBA4, DBA1′, DBA2′) is stored in a digital construction diary.

In some embodiments, the digital snapshot (DBA1-DBA4, DBA1′, DBA2′) containing the digital identifier (DIK1-DIK4) of the user (B1-B3) is stored in a building information model (BIM).

In some embodiments, the digital snapshot (DBA1-DBA4, DBA1′, DBA2′) includes the documentation of parameters and/or configurations and/or measured values of a technical system.

As another example, some embodiments include use of an appropriately configured mobile communication terminal (MG1-MG3, MG2′) for authenticating digital snapshots (DBA1-DBA4, DBA1′, DBA2′), wherein a digital snapshot is created by a first capture apparatus (EAE) of the mobile communication terminal by a user (B1-B3), wherein a digital, in particular a digital-visual, identifier (DIK1-DIK4) of the user (B1-B3) of the mobile communication terminal (MG1-MG3, MG2) is determined by a second capture apparatus (ZAE) of the mobile communication terminal (MG1-MG3, MG2′) at the same time as the digital snapshot (DBA1-DBA4, DBA1′, DBA2′), wherein the digital identifier (DIK1-DIK4) of the user (B1-B3) is overlaid into the digital snapshot (DBA1-DBA4, DBA1′, DBA2′) and/or is added digitally, and wherein the digital snapshot (DBA1-DBA4, DBA1′, DBA2) containing the digital identifier (DIK1-DIK4) of the user (B1-B3) is stored in a machine-readable format, wherein a digital watermark and/or a further digital identifier (for example PKI) of the user (B1-B3) and/or a digital signature of the user (B1-B3) and/or the name (BN1, BN2) of the user (B1-B3) are overlaid on the digital snapshot (DBA1-DBA4, DBA1′, DBA2′) and/or are digitally added, wherein the identity of the user is examined by a certified infrastructure and is stored in the digital snapshot (DBA1-DBA4, DBA1′, DBA2′).

### BRIEF DESCRIPTION OF THE DRAWINGS

The teachings and some example embodiments of the present disclosure are explained using the example of the following figures, in which:

FIG. 1 shows a first exemplary system for authenticating digital snapshots incorporating teachings of the present disclosure;

FIG. 2 shows a second exemplary system for authenticating digital snapshots incorporating teachings of the present disclosure;

FIG. 3 shows a first exemplary digital snapshot incorporating teachings of the present disclosure;

FIG. 4 shows a second exemplary digital snapshot incorporating teachings of the present disclosure;

FIG. 5 shows an exemplary capture device incorporating teachings of the present disclosure; and

FIG. 6 shows flow diagram for an example method for authenticating digital snapshots incorporating teachings of the present disclosure.

### DETAILED DESCRIPTION

The systems and methods described herein provide that, at the same time as the digital snapshot is recorded (i.e. during the recording process of the digital snapshot for photo-documentation of an appropriate object), a digital-visual identifier of the user (i.e. the person who created the snapshot) is determined. The digital-visual identifier of the user can take the form of a photograph and/or a fingerprint of the user (for example using a fingerprint sensor). The digital snapshot comprises overlaying the photographs from the front and rear camera, these photographs being created simultaneously by triggering both cameras. Thanks to the simultaneous snapshot from the front and rear camera of the capture device (for example smartphone, tablet computer) and thanks to overlaying in the digital snapshot it is thus possible to achieve live documentation of an object with integrated evidence of authorship. This thus results in an image verification with additional embedded visual proof of the person adducing the evidence (i.e. the photographer).

Examples of certified infrastructures include a public key infrastructure or a self-sovereign identity infrastructure (SSI). In the case of a public key infrastructure (PKI), use is made for example of digital certificates for digital signing, encryption and communication. To this end, a public key infrastructure (PKI) includes, among other things, a certification authority for the provision of the certificates, a registration authority where certificates can be applied for, a comparison service (for example in the form of an LDAP server (Lightweight Directory Access Protocol) or an X.500 server), a searchable directory for issued certificates, a validation service, which among other things enables certificates to be verified in real time.

In the case of a self-sovereign identity infrastructure (SSI), a user can generate identifiers that can be used to verify identity data. The identity data can be stored and managed using a digital wallet. Further example of certified infrastructures include electronic or digital identities (E-ID, e-ID, eID), etc. By using a certified infrastructure to check the identity of the user it is ensured that the user really is the user who has the identity data assigned to said user by the certified infrastructures. Further examples of certified infrastructures are post-ident or video-ident methods.

In some embodiments, steps (VS1) and (VS2) are performed simultaneously. In this disclosure, simultaneously means: at the same instant, at the same moment, contemporaneously, concurrently, at the same time, coincident, all at once. In particular it means in this connection that steps (VS1) and (VS2) are performed within a period of less than 1 second, e.g. of less than 0.5 seconds.

The digital identifier of the user is thereby embedded into the digital snapshot. The digital identifier of the user may be embedded into the digital snapshot by a digital signature of the user and/or by a blockchain mechanism. This increases the security and the evidence of authorship of the snapshot.

In some embodiments, the digital snapshot may be stored together with the digital identifier of the user in a machine-readable format in a single digital file or in a single digital artifact (for example NFT, Non-Fungible Token).

In some embodiments, the digital identifier of the user takes the form of facial recognition (for example using appropriate facial recognition technology, such as for example FaceID) and/or a digital photograph (photograph taken by a rear secondary camera). This too increases the security and the evidence of authorship of the snapshot. The facial recognition technology can for example be based on 2D or 3D methods. This thus provides secure proof, e.g. with automatic facial recognition, of who created the photo-documentation.

In some embodiments, current-location GPS data and/or current time information is overlaid on the digital snapshot and/or is added digitally. As a result it is ensured, for documentation and/or audit purposes, when and where the snapshot was created. A digital watermark and/or a further digital identifier (for example PKI) of the user and/or a digital signature of the user and/or the name of the user may be overlaid on the digital snapshot and/or is added digitally. This too increases the security and the evidence of authorship of the snapshot.

In some embodiments, the digital snapshot is used as construction progress documentation for the creation of a structure, and the digital snapshot is stored in a digital construction diary. Structures can for example be: buildings, tunnels, bridges, technical installations, chemical plants. The documentation about the operation of a construction site is also of great importance for smooth execution of a construction project. Whether in writing by keeping a construction diary, logs and construction site reports or visually in the form of comprehensive photo-documentation. In the latter case, proper construction management may include: accurate and comprehensible photo-documentation of the construction project, from the execution on the construction site to the acceptance and use of the building.

In order to record everything in full it is important that all those involved in the project take detailed and clear photographs documenting each step of their work on site. Although project personnel, subcontractors and other partners can see things for themselves on site every day, the photographic documentation of work performed and of facts on a construction site is always the best option. People can understand photographs better and remember images rather than what they were told or what they have read as text. In view of this, proper photo-documentation of work or problems on site helps to increase the productivity of the construction site and to improve daily reporting. Not only can it warn employees of any hazards, but it also simplifies internal and external communication thanks to continuous updates about the status of the construction project. These photographs can be taken very easily, for example with a smartphone or tablet.

A construction diary may be used to document the construction of a building. The construction diary in particular records the completion of construction phases and any defects identified, or documents these. The site manager or the appointed architect normally keeps the construction diary. The construction diary may be kept regularly. It is best to fill it out daily, but at least every time the architect or site manager visits the construction site. A construction diary may include details of the general progress of construction; identified construction defects, damage, faults or deviations from the norm; minutes of meetings; acceptance reports of subsections or construction phases. The construction diary may be kept as an electronic construction diary, in which the entries are stored in an appropriately configured database and/or in a building information model (BIM). An electronic construction diary can also contain appropriate photographs and/or videos for a building. The entries in the electronic construction diary can be made for example using an app of a mobile communication terminal (for example smartphone, tablet computer).

Because of the complexity of construction projects, the number of photographs collected can quickly result in excessive administrative effort. After all, the responsible persons often have to view thousands of photographs in order to present the facts clearly. For evidential purposes it must be possible to be able to assign these photographs to the photographer. By connecting the theoretical digital planning in the office with the real construction site, construction errors and costly corrections can be prevented in advance. Users are enabled to utilize their mobile devices to retrieve the current planning status and all available BIM data and with the help of augmented reality technology to compare it with the actual construction progress.

In some embodiments, the digital snapshot is associated with the digital identifier of the user in a building information model (BIM). This means that it is possible to access the digital snapshot in particular for documentation of the construction progress and/or for an audit of a subsection.

In some embodiments, the digital snapshot is used as progress documentation, such as for example during assembly, commissioning or inspection of a technical installation, a technical system, a machine or a device, or that the digital snapshot is used as proof of delivery or proof of collection of goods, such as for example packages, pallets or even (registered) letters or documents, and the digital snapshot is stored in digital progress documentation.

In some embodiments, the method is implemented by an appropriately configured mobile communication terminal (for example smartphone, tablet computer). Smartphones and tablet computers are widespread and are normally fitted with the devices required for the performance of the method (for example cameras, storage and processor means, communication means).

In some embodiments, the digital snapshot (DBA1-DBA4, DBA1′, DBA2) includes the documentation of parameters and/or configurations and/or measured values of a technical system.

As another example, some embodiments include a system for the performance of one or more of the methods described herein. An arrangement for the performance of the methods can be implemented using standard components (COTS, commercials off the shelf).

Some embodiments include a system for authenticating digital snapshots (for example photograph, video, point cloud), wherein a digital snapshot is created by a capture device (appropriate digital camera, smartphone, scanner) by a user using a first capture apparatus (primary camera, front camera), wherein thanks to a second capture apparatus (rear secondary camera) a digital identifier of the user can be determined at the same time as the digital snapshot, wherein the digital identifier of the user is in particular overlaid visually into the digital snapshot and/or can be added digitally, and wherein the digital snapshot containing the digital identifier of the user can be stored in a machine-readable format on a suitable storage medium, wherein a digital watermark and/or a further digital identifier (for example PKI) of the user and/or a digital signature of the user and/or the name (BN1, BN2) of the user is overlaid on the digital snapshot and/or can be added digitally, wherein the identity of the user can be stored in the digital snapshot following verification by a certified infrastructure.

A digital-visual identifier of the user (i.e. the person who created the snapshot) is determined at the same time as the recording of the digital snapshot by the capture device (i.e. during the recording process of the digital snapshot for photo-documentation of an appropriate object). The digital-visual identifier of the user can take the form of a photograph and/or a fingerprint of the user. The digital snapshot comprises overlaying the recordings from the first and second capture apparatus, these photographs being created by (simultaneously) triggering both apparatuses. Thanks to the simultaneous snapshot from the first and second capture apparatus of the capture device (for example smartphone, tablet computer) and thanks to overlaying in the digital snapshot it is thus possible to achieve live documentation of an object with integrated evidence of authorship.

The digital identifier of the user may be embedded into the digital snapshot. The digital identifier of the user may be embedded into the digital snapshot by a digital signature of the user and/or by a blockchain mechanism. This increases the security and the evidence of authorship of the snapshot.

In some embodiments, the digital identifier of the user takes the form of facial recognition (FaceID) and/or a digital photograph (photograph by rear secondary camera, photograph of the user/photographer). The digital identifier of the user is in particular a digital-visual identifier.

In some embodiments, current-location GPS data is overlaid on the digital snapshot and/or is added digitally. As a result it is ensured, for documentation and/or audit purposes, when and where the snapshot was created.

In some embodiments, a digital watermark and/or a further digital identifier (for example PKI) of the user and/or a digital signature of the user is overlaid on the digital snapshot and/or is added digitally. This too increases the security and the evidence of authorship of the snapshot.

In some embodiments, the digital snapshot is used as construction progress documentation for the creation of a structure, and the digital snapshot is stored in a digital construction diary. Structures can for example be: buildings, tunnels, bridges, technical installations, chemical plants.

In some embodiments, the digital snapshot containing the digital identifier of the user is stored in a building information model (BIM). This means that it is possible to access the digital snapshot in particular for documentation of the construction progress and/or for an audit of a subsection.

Some embodiments include an appropriately configured mobile communication terminal (for example smartphone, tablet computer) for authenticating digital snapshots (for example photograph, video, point cloud), wherein a digital snapshot is created by a first capture apparatus (for example appropriate digital camera, smartphone, scanner) of the mobile communication terminal by a user, wherein at the same time as the digital snapshot a digital, in particular a digital-visual, identifier of the user of the mobile communication terminal is determined by a second capture apparatus (rear secondary camera) of the mobile communication terminal, wherein the digital identifier of the user is overlaid into the digital snapshot and/or is added digitally, and wherein the digital snapshot containing the digital identifier of the user is stored in a machine-readable format. Smartphones and tablet computers are widespread and are normally fitted with the devices required for the performance of the method (for example cameras, storage and processor means, communication means).

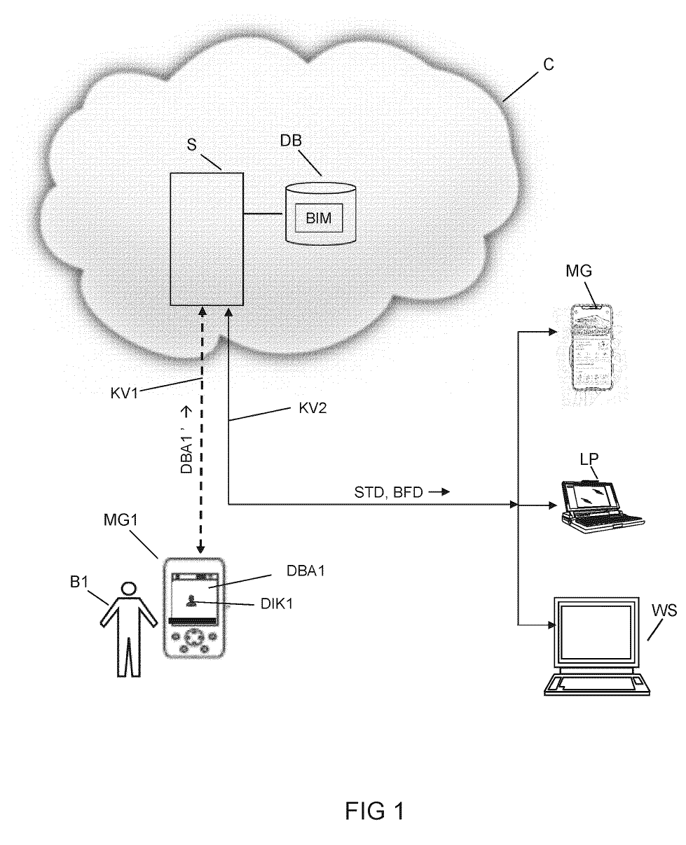

FIG. 1 shows a first exemplary arrangement for authenticating digital snapshots DBA1, DBA1, wherein a digital snapshot DBA1, DBA1′ is created by a capture device MG1 (for example smartphone) by a user B1 using a first capture apparatus (for example primary camera of a smartphone), wherein a digital identifier DIK1 of the user B1 can be determined by a second capture apparatus (for example rear secondary camera of a smartphone) at the same time as the digital snapshot DBA1, DBA1′, wherein the digital identifier DIK1 of the user B1 is overlaid in particular visually into the digital snapshot DBA1, DBA1′ and/or can be added digitally, and wherein the digital snapshot DBA1, DBA1′ containing the digital identifier DIK1 of the user B1 can be stored in a machine-readable format on a suitable storage medium.

In the illustration in accordance with FIG. 1 the digital snapshot DBA1 created with the capture device MG1 (for example smartphone), for example of an object in a building, is imported, with the digital identifier DIK1 of the user B1 embedded therein, via a suitable communication connection KV1 (for example radio link, internet) in a machine-readable format DBA1′ (for example raster graphic or vector graphic) to a server S, to be saved (stored) in a database DB. The digital snapshot DBA1, DBA1′ can for example be stored in a building information model BIM. For example as proof of repair or maintenance work carried out in a building. The server S comprises suitable processing, storage and communication means. The server S and the database DB can be implemented for example in an appropriately configured cloud infrastructure C. The server S is advantageously connected via a communication link KV2 (for example radio, internet) to output devices, for outputting or transmitting status data STD and/or construction progress data BFD. The output devices can for example be a mobile communication terminal MG, a laptop LP or a workstation WS.

At the same time as the digital snapshot DBA1 is recorded (i.e. during the recording process of the digital snapshot for photo-documentation of an appropriate object) a digital-visual identifier DIK1 of the user B1 (i.e. the person who created the snapshot) is determined. The digital-visual identifier DIK1 of the user B1 can take the form of a photograph and/or a fingerprint of the user B1 (for example using a fingerprint sensor). The digital snapshot DBA1 comprises overlaying the photographs from the front and rear camera, these photographs being created simultaneously by triggering both cameras (for the recordings). Thanks to the simultaneous snapshot from the front and rear camera of the capture device MG1 (for example smartphone, tablet computer) and thanks to overlaying in the digital snapshot DBA1 it is thus possible to achieve live documentation of an object with integrated evidence of authorship.

The digital identifier DIK1 of the user B1 is therefore embedded into the digital snapshot DAB1. The digital identifier DIK1 of the user B1 may be embedded into the digital snapshot DBA1 by a digital signature of the user B1 and/or by a blockchain mechanism (blockchain method, distributed ledger technology). This increases the security and the evidence of authorship of the snapshot.

The digital snapshot DAB1, DAB1′ may be stored together with the digital identifier DIK1 of the user B1 in a machine-readable format in a single digital file or in a single digital artifact (for example NFT, Non-Fungible Token). The digital identifier DIK1 of the user B1 may comprise facial recognition (FaceID) and/or a digital photograph.

Current-location GPS data may be overlaid on the digital snapshot DBA1 and/or is added digitally, for example is visibly embedded (overlaid) on the digital snapshot DBA1 and/or as metadata. A digital watermark and/or a further digital identifier (for example PKI) of the user B1 and/or a digital signature of the user B1 may be overlaid on the digital snapshot DBA1 and/or are added digitally.

In some embodiments, the digital 1 snapshot DBA1 is used as construction progress documentation for the creation of structure, and the digital snapshot DBA1 is stored in a digital construction diary. The digital snapshot DBA1 containing the digital identifier DIK1 of the user B1 may be saved or stored in a building information model BIM.

In some embodiments, the digital snapshot DBA1, DBA1′ includes the documentation of parameters and/or configurations and/or measured values of a technical system.

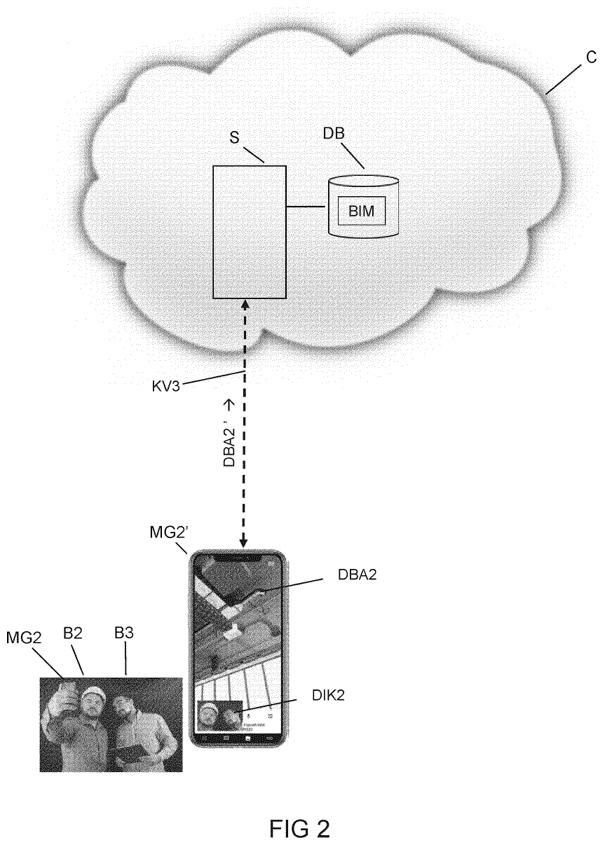

FIG. 2 shows a second exemplary arrangement for authenticating digital snapshots DBA2, DBA2, wherein a digital snapshot DBA2, DBA2′ is created by a capture device MG2, MG2′ (for example smartphone) by one or more users B2, B3 using a first capture apparatus (for example primary camera of a smartphone), wherein a digital identifier DIK2 of the users B2, B3) can be determined by a second capture apparatus (for example rear secondary camera of a smartphone) at the same time as the digital snapshot DBA2, DBA2, wherein the digital identifier DIK2 of the users B2, B3 in particular is overlaid visually into the digital snapshot DBA2, DBA2′ and/or can be added digitally, and wherein the digital snapshot DBA2, DBA2′ containing the digital identifier DIK2 of the users B2, B3 can be stored in a machine-readable format on a suitable storage medium.

In the illustration in accordance with FIG. 2 the digital snapshot DBA2 created with the capture device MG2, MG2′ (for example smartphone), for example of an object in a building, and containing the digital identifier DIK2 of the users B2, B3 embedded therein, is imported via a suitable communication link KV3 (for example radio link, internet) in a machine-readable format DBA2′ (for example raster graphic or vector graphic) to a server S, to be saved (stored) in a database DB. The digital snapshot DBA2, DBA2′ can for example be stored in a building information model BIM. For example as evidence of repair or maintenance work carried out in a building. The server S comprises suitable processing, storage and communication means. The server S and the database DB can be implemented for example in an appropriately configured cloud infrastructure C.

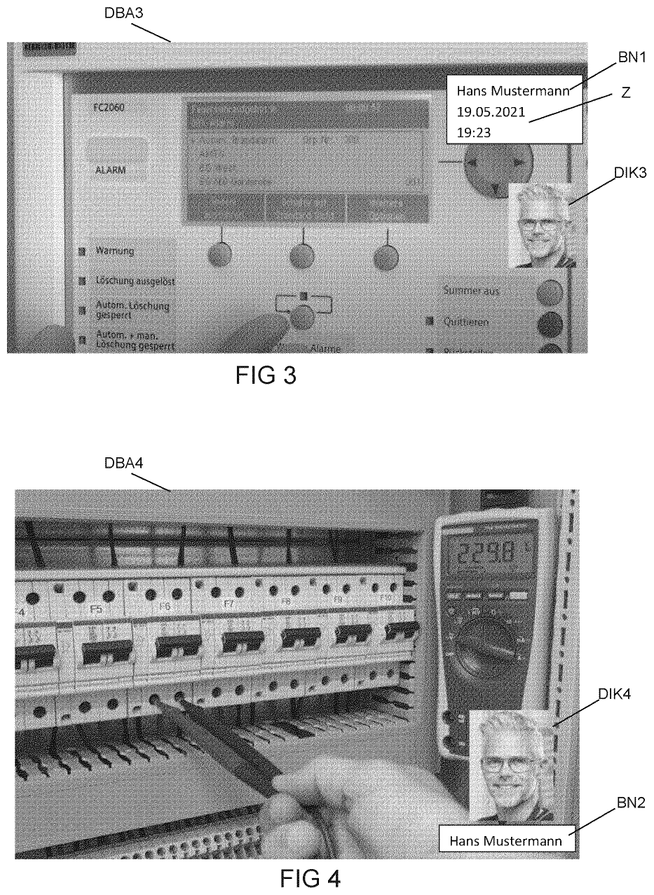

FIG. 3 shows a first exemplary digital snapshot DAB3 for a first exemplary technical device. The digital snapshot DAB3 includes as a digital identifier DIK3 the photograph of the appropriate user.

The digital snapshot DAB3 furthermore includes the username BN1 of the user, as well as time details Z (date and time of the creation of the snapshot DAB3). The digital snapshot DAB3 includes exemplary documentation of the settings and/or chosen parameters (configurations) of a technical system.

FIG. 4 shows a second exemplary digital snapshot DAB4 for a second exemplary technical device. The digital snapshot DAB4 includes as a digital identifier DIK4 the photograph of the appropriate user. The digital snapshot DAB4 furthermore includes the username BN2 of the user who created the snapshot DAB4. The digital snapshot DAB4 includes exemplary documentation of a measured value of a technical system.

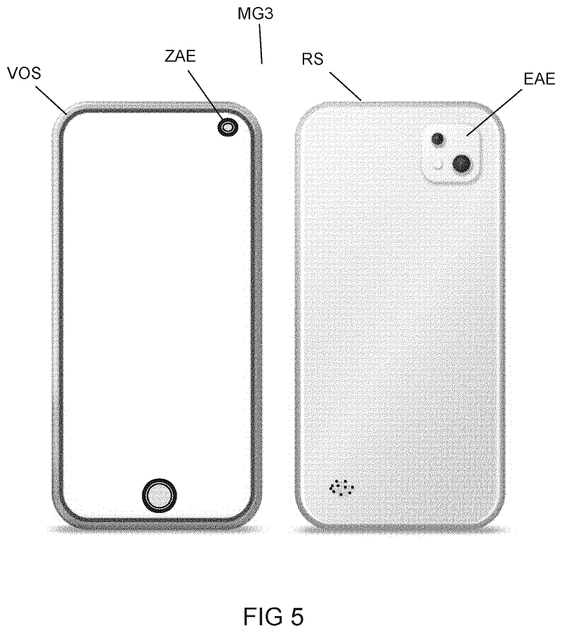

FIG. 5 shows an exemplary capture device MG3 (for example a mobile communication terminal), configured for authenticating digital snapshots, wherein a digital snapshot is created by a first capture apparatus (EAE) of the mobile communication terminal MG3 by a user, wherein a digital, in particular a digital-visual, identifier of the user (and creator of the digital snapshot) of the mobile communication terminal MG3 is determined (or is created by taking a photo) by a second capture apparatus (ZAE) of the mobile communication terminal MG3 at the same time as the digital snapshot, wherein the digital identifier of the user is overlaid into the digital snapshot and/or is added digitally, and wherein the digital snapshot is stored together with the digital identifier of the user in a machine-readable format in a single digital file or a single digital artifact (for example NFT, Non-Fungible Token).

In the case of the exemplary capture device MG3 (for example a mobile communication terminal, smartphone) in accordance with FIG. 5, the first capture apparatus EAE is mounted on the rear RS of the mobile communication terminal MG3, and the second capture apparatus ZAE on the front VOS of the mobile communication terminal MG3.

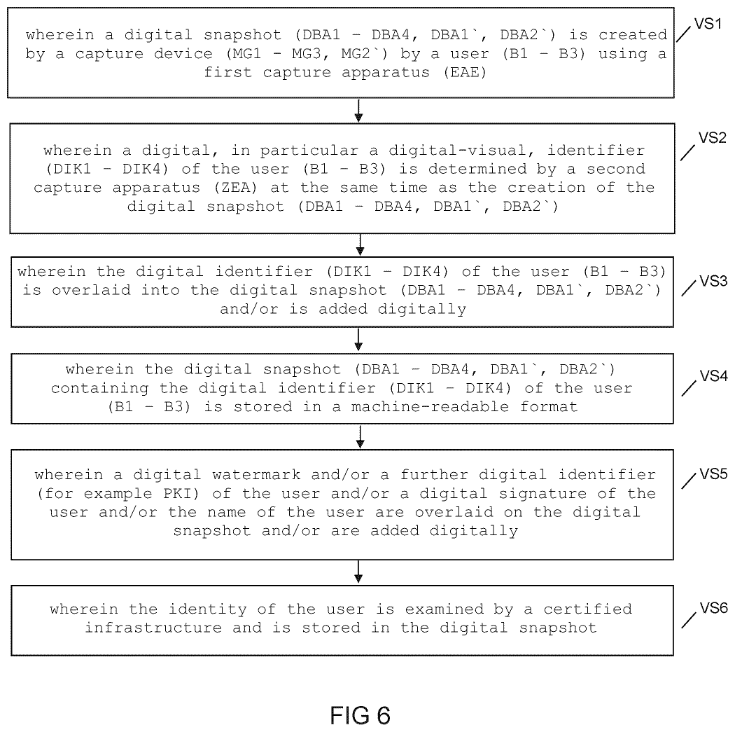

FIG. 6 shows an exemplary flow diagram for a method for authenticating digital snapshots (DBA1-DBA4, DBA1′, DBA2),
(VS1) wherein a digital snapshot (DBA1-DBA4, DBA1′, DBA2) is created by a capture device (MG1-MG3, MG2) by a user (B1-B3) using a first capture apparatus (EAE),
(VS2) wherein a digital, in particular a digital-visual, identifier (DIK1-DIK4) of the user (B1-B3) is determined by a second capture apparatus (ZEA) at the same time as the creation of the digital snapshot (DBA1-DBA4, DBA1′, DBA2),
(VS3) wherein the digital identifier (DIK1-DIK4) of the user (B1-B3) is overlaid into the digital snapshot (DBA1-DBA4, DBA1′, DBA2) and/or is added digitally, and
(VS4) wherein the digital snapshot (DBA1-DBA4, DBA1′, DBA2) containing the digital identifier (DIK1-DIK4) of the user (B1-B3) is stored in a machine-readable format,
(VS5) wherein a digital watermark and/or a further digital identifier (for example PKI) of the user and/or a digital signature of the user and/or the name of the user are overlaid on the digital snapshot and/or are added digitally,
(VS6) wherein the identity of the user is examined by a certified infrastructure and is stored in the digital snapshot.

In some embodiments, the digital identifier (DIK1-DIK4) of the user (B1-B3) takes the form of facial recognition (FaceID) and/or a digital photograph. In some embodiments, current-location GPS data and/or current time information (Z) is overlaid on the digital snapshot (DBA1-DBA4, DBA1′, DBA2′) and/or is added digitally.

In some embodiments, a digital watermark and/or a further digital identifier (for example PKI) of the user (B1-B3) and/or a digital signature of the user (B1-B3) and/or the name (BN1, BN2) of the user (B1-B3) are overlaid on the digital snapshot (DBA1-DBA4, DBA1′, DBA2′) and/or are added digitally. In some embodiments, the digital snapshot (DBA1-DBA4, DBA1′, DBA2′) is used as construction progress documentation for the creation of a structure, and the digital snapshot (DBA1-DBA4, DBA1′, DBA2) is stored in a digital construction diary.

In some embodiments, the digital snapshot (DBA1-DBA4, DBA1′, DBA2′) containing the digital identifier (DIK1-DIK4) of the user (B1-B3) is assigned to a building information model (BIM) or is saved (stored) in a building information model (BIM).

In some embodiments, the method is implemented by an appropriately configured mobile communication terminal (MG1-MG3, MG2). The mobile communication terminal (MG1-MG3, MG2′) can for example be a smartphone or a tablet computer.

At the same time as the digital snapshot is recorded (i.e. during the recording process of the digital snapshot for photo-documentation of an appropriate object) a digital-visual identifier of the user (i.e. the person who created the snapshot) is determined. The digital-visual identifier of the user can take the form of a photograph and/or a fingerprint of the user (for example using fingerprint sensor). The digital snapshot comprises overlaying the photographs from the front and rear camera, these photographs being created simultaneously by triggering both cameras. Thanks to the simultaneous snapshot from the front and rear camera of the capture device (for example smartphone, tablet computer) and thanks to overlaying in the digital snapshot it is thus possible to achieve live documentation of an object with integrated evidence of authorship.

In some embodiments, the digital identifier of the user is embedded into the digital snapshot. In some embodiments, the digital identifier of the user is embedded into the digital snapshot by a digital signature of the user and/or by a blockchain mechanism. This increases the security and the evidence of authorship of the snapshot.

In some embodiments, an arrangement for the performance of the inventive method can be implemented using standard components (for example appropriately equipped and configured smartphone or tablet computers).

Reference characters

| | |
|---|---|
| S | Server |
| BIM | Building information model |
| DB | Database |
| MG, MG1-MG3, MG2′ | Mobile communication terminal |
| VOS | Front |
| RS | Rear |
| EAE, ZAE | Capture apparatus |
| DBA1-DBA4, DBA1′ DBA2′ | Digital snapshot |
| DIK1-DIK4 | Digital identifier |
| B1-B3 | User |
| BN1, BN2 | Username |
| STD | Status data |
| BFD | Construction progress data |
| LP | Laptop |
| WS | Workstation |
| C | Cloud infrastructure |
| KV1-KV3 | Communication link |
| VS1-VS6 | Method step |

What is claimed is:

1. A method for authenticating digital snapshots, the method comprising:
creating a digital snapshot using a capture device by a user using a first capture system;
determining a digital identifier of the user using a second capture apparatus at the same time as the creation of the digital snapshot;
overlaying the digital identifier of the user into the digital snapshot;
storing the digital snapshot containing the digital identifier the user in a machine-readable format;
adding a digital watermark and/or a further digital identifier of the user and/or a digital signature of the user and/or a name of the user to the digital snapshot; and
examining an identity of the user by a certified infrastructure and storing the identity in the digital snapshot.

2. The method as claimed in claim 1, wherein the digital identifier of the user includes facial recognition and/or a digital photograph.

3. The method as claimed in claim 1, further comprising adding current-location GPS data and/or current time information to the digital snapshot.

4. The method as claimed in claim 1, further comprising using the digital snapshot as construction progress documentation for the creation of a structure, and storing the digital snapshot in a digital construction diary.

5. The method as claimed in claim 1, further comprising assigning the digital snapshot containing the digital identifier of the user in a building information model.

6. The method as claimed in claim 1, wherein the method is implemented by an appropriately configured mobile communication terminal.

7. The method as claimed in claim 1, wherein the digital snapshot includes the documentation of parameters and/or configurations and/or measured values of a technical system.

8. (canceled)

9. A system for authenticating digital snapshots the system comprising:
a first image capture device to capture a digital snapshot by a user;
a second image capture device to determine a digital identifier of the user at simultaneously as the digital snapshot is captured;
wherein the digital identifier of the user is overlaid into the digital snapshot;
a storage medium to store the digital snapshot containing the digital identifier of the user;
wherein a digital watermark and/or a further digital identifier of the user digital signature of the user and/or a name of the user are overlaid on the digital snapshot; and
the digital snapshot includes information corresponding to an identity of the user.

10. The system as claimed in claim 9, wherein the digital identifier of the user includes facial recognition and/or a digital photograph.

11. The system as claimed in claim 9, wherein current-location GPS data is overlaid on the digital snapshot.

12. The system as claimed in claim 9, wherein the digital snapshot is used as construction progress documentation for the creation of a structure, and the digital snapshot is stored in a digital construction diary.

13. The system as claimed in claim 9, wherein the digital snapshot containing the digital identifier of the user is stored in a building information model.

14. The arrangement as claimed in claim 9, wherein the digital snapshot includes documentation of parameters and/or configurations and/or measured values of a technical system.

15. (canceled)
